(19) United States
(12) Patent Application Publication
(10) Pub. No.: US 2010/0288062 A1
(43) Pub. Date: Nov. 18, 2010

(54) Two Axis Solar Tracking System

(75) Inventor: Steven Michael Meyer, Georgetown, TX (US)

Correspondence Address: Steven M. Meyer, 137 Ridgecrest Road, Georgetown, TX, 78628, US

(73) Assignee: SOLID TECH INC, Georgetown, TX (US)

(21) Appl. No.: 12/708,661

(22) Filed: Feb. 19, 2010

Related U.S. Application Data
(60) Provisional application No. 61/153,915, filed on Feb. 19, 2009.

(51) Int. Cl. F16H 21/00; F16H 1/04; F16H 1/18; G06F 17/00

(52) U.S. Cl. 74/25; 74/422; 74/424.7; 700/90

(57) ABSTRACT

An electromechanical solution for 2 axis solar tracking is disclosed that is suitable for application with a single solar heat, hot water or photovoltaic panel. 3 points of contact are arranged in a triangle on the back of the panel with 2 points of contact connected by linear actuators and flexible couplings. The third point of contact is a spherical bearing at the base of the panel. The actuators are independently adjustable in length by using electric motors according to a microprocessor program. In this way, 2 rotary axes of motion with limited angles are achieved which can orient the panel to the sun with minimal hardware. Since only one solar panel is being controlled the mechanical force required is minimized.

### BACKGROUND OF THE INVENTION

The goal of solar tracking systems for photovoltaic panels and solar heat collectors is to maximize the energy gained by these system. This is accomplished by maintaining a perpendicular orientation between the sun and the energy collector as the sun travels through the sky. Most photovoltaic panels, regardless of the chemistry, will gain more than 30% in total output with 2 axis tracking (National Renewable Energy Laboratories data claims 36% for 2 axis tracking).

Solar tacking systems are generally organized into groups of panels, often 20 or more at a time, to allow a single or two actuators to do tracking at a reduced cost per panel. These systems require significant counterweight, often in the form of poured concrete foundations, making them unsuitable for commercial flat roofs or residential application. As a result of this industry trend, there has not been a cost effective method for articulating a single solar panel for the needed motion.

In order to correct for annual changes in elevation angle of the sun's rays, a separate axis of rotation is required. This movement is an angle of rotation around an axis at one end of the panel across the short dimension, width, of the rectangle. (see FIG. 1)

In daily operation, as the sun rises and sets, a second axis of rotation is needed, the azimuth. An azimuth rotation is a rotary motion, at the mid-line of and around the long axis of the solar panel. (see FIG. 2)

The two forms of rotary motion must be combined in order to achieve maximum performance in the solar panel. However, it is difficult to create the necessary motion and there is considerable cost and complexity involved in most systems. In the current practice there are no two axis systems that are suited to commercial flat roof installations, leading to significant under utilization of equipment to generate solar power.

### BRIEF DESCRIPTION OF THE DRAWINGS

FIGS. 1 & 2 provide illustrations of the motion requirement for tracking the sun with rectangular panels.

FIG. 3 shows the actuator system executing the azimuth motion

FIG. 4 shows the actuator system executing the elevation motion

FIG. 5 shows a system block diagram including the micro-controller and motor drives

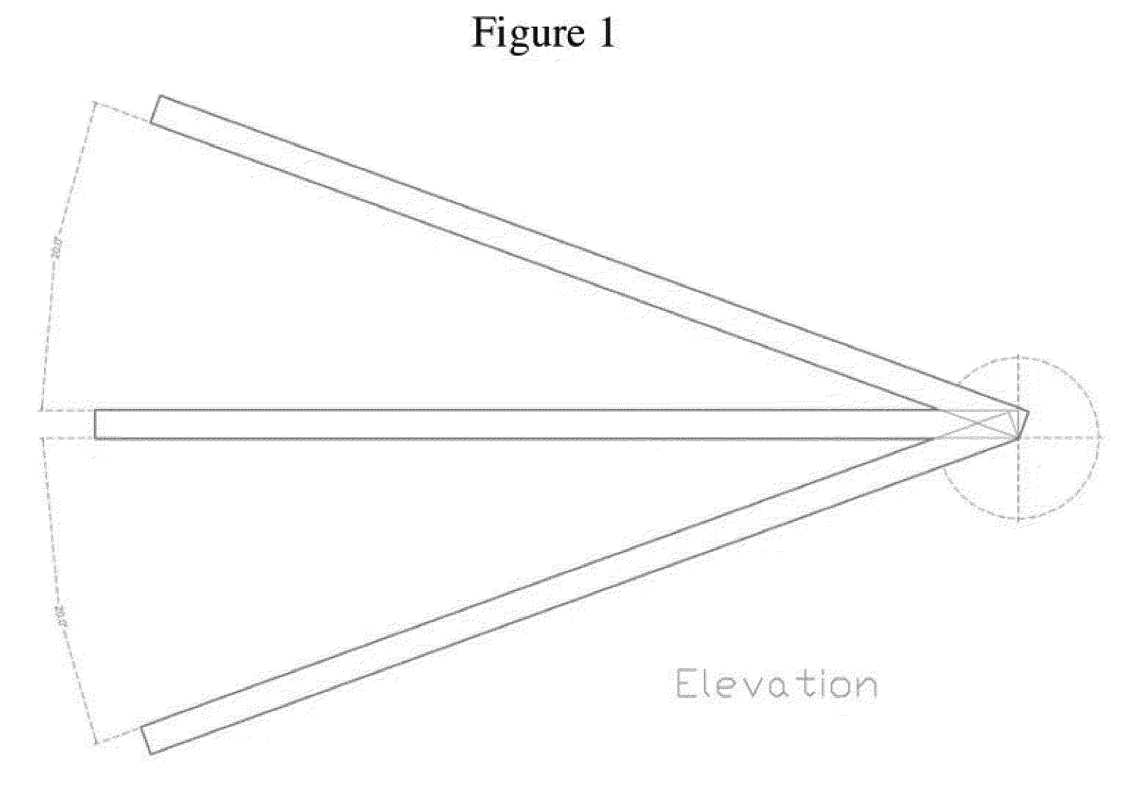

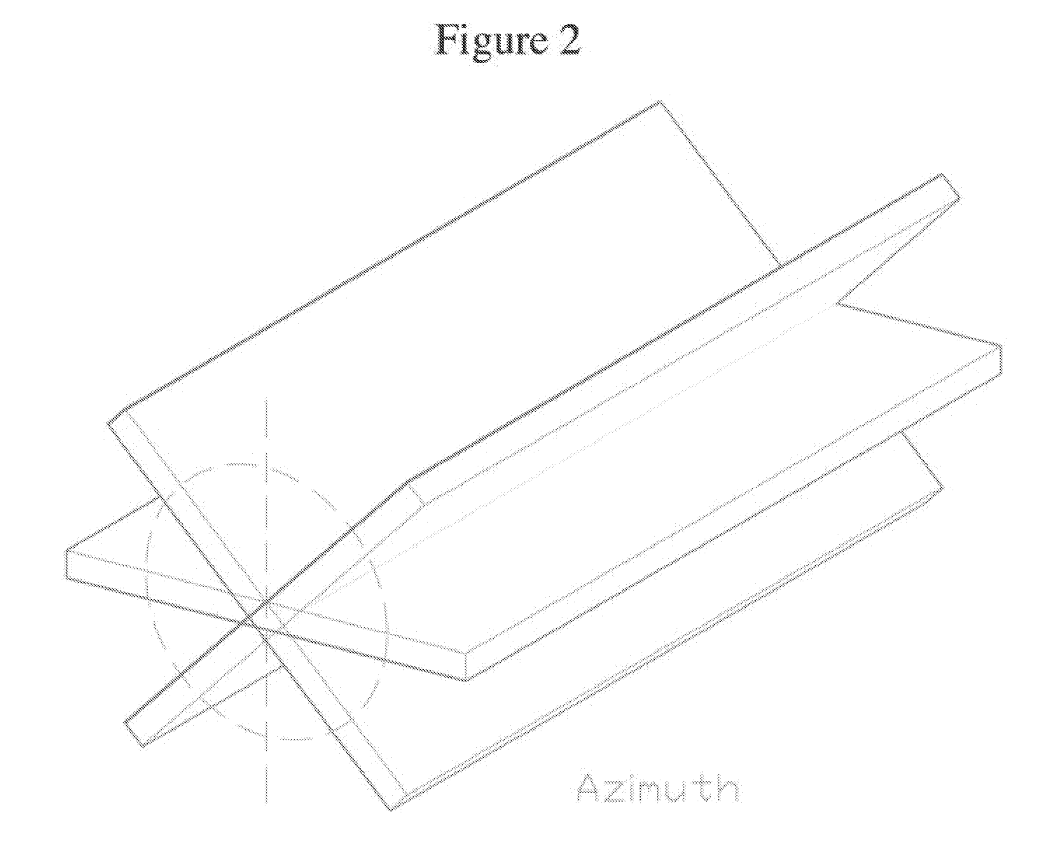

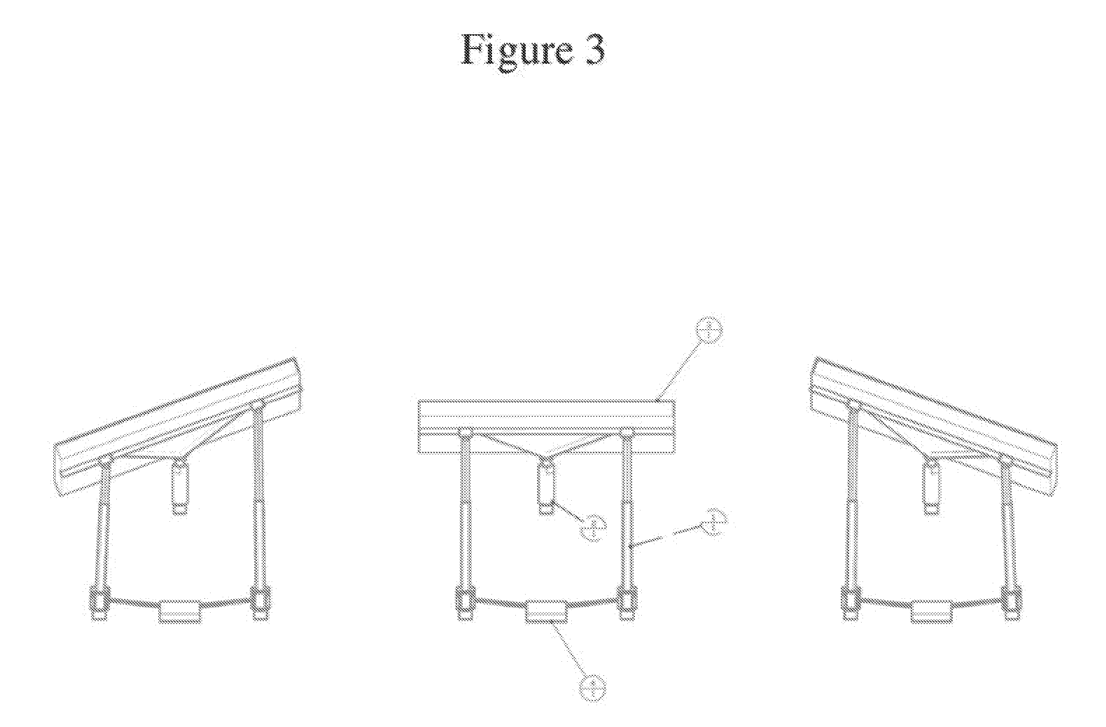

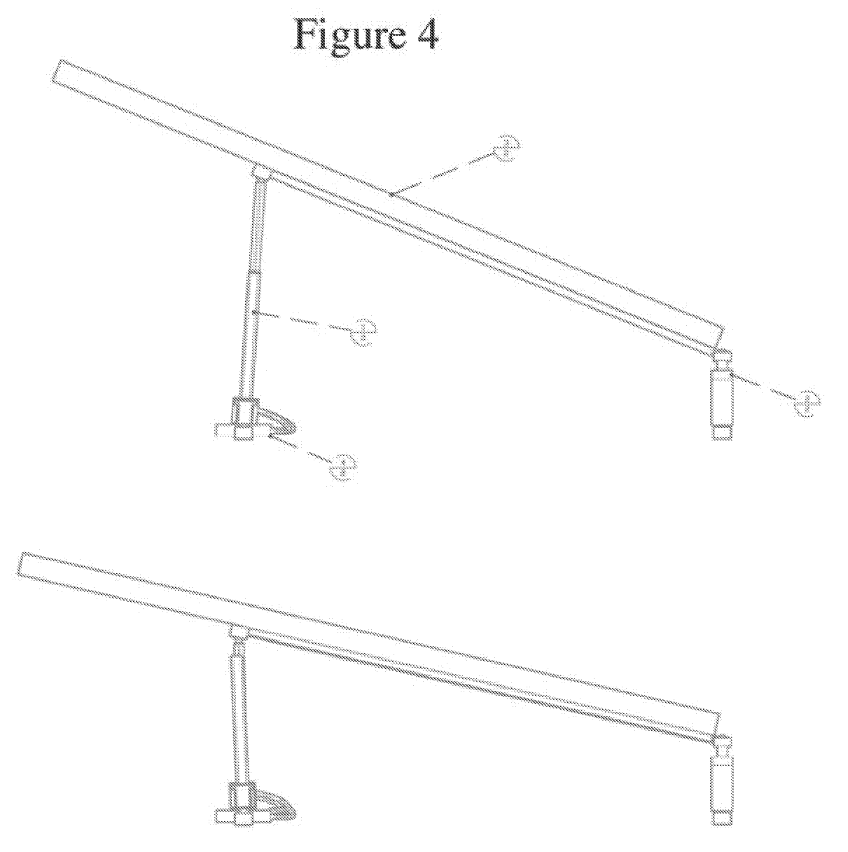

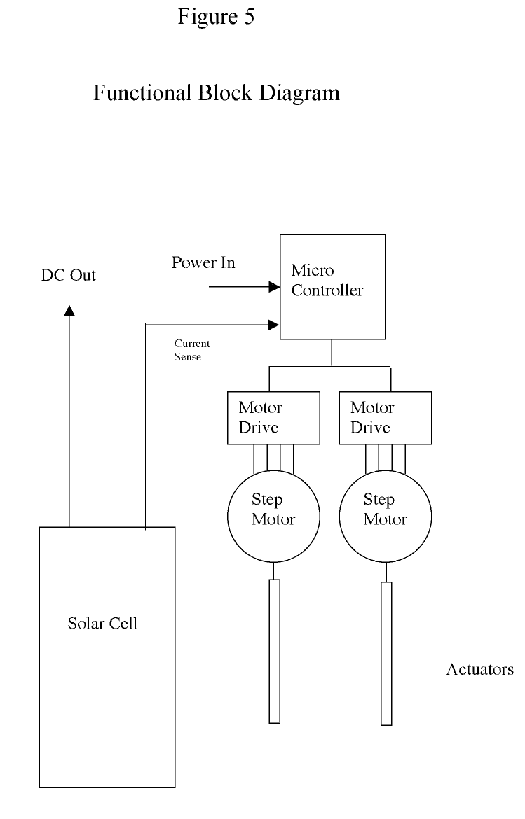

### DISCLOSURE OF THE INVENTION

The present invention is a method and apparatus for a solar tracker. This disclosure describes numerous specific details in order to provide a thorough understanding of the present invention. One skilled in the art will appreciate that one may practice the present invention without these specific details. Additionally, the disclosure does not describe some well known items in detail, in order not to obscure the present invention.

A 2 axis system is proposed that can be powered with linear actuators based on an integrated stepping motor and lead screw combination which provides the necessary structural support and 2 degrees of freedom to perform the needed motion. Since the solution is designed for use with only one solar panel the mechanical forces and wind load are much lower and easier to manage.

Other embodiments of the present invention will be apparent to those skilled in the art after considering this disclosure or practicing the disclosed invention. The specification and examples are exemplary only, with the true scope of the present invention being determined by the following claims.

A solar tracking system in which two linear actuators are combined with a spherical bearing pivot to achieve two rotary axes of motion. A microprocessor controller is used to control the electric motors (stepping motors in the preferred embodiment) and implement the needed position control algorithm. An optional input from the output of the solar panel, or an auxiliary photo-detector can be used as a control input to optimize the electrical output of the panel.

1. An actuator system based on 3 points of contact to a flat plane. Two points of contact are actively controlled by linear actuators and attached with flexible couplings, such as tie rod ends, the third point of contact being passive and pivoting on a spherical bearing.

2. The 2 Linear actuators, can be of any design, rack and pinion, lead screw, etc., driven by electric motors and operated independently to produce both azimuth and elevation motion.

3. The two actuators are controlled by a microprocessor, which can be programmed to follow heuristic, maximum power output, or any desired control program.
